(19) United States
(12) Patent Application Publication
(10) Pub. No.: US 2002/0109700 A1
(43) Pub. Date: Aug. 15, 2002

(54) Method and apparatus for modifying a bit field in a memory buffer

(75) Inventors: Chun Kee Ma, Hong Kong (HK); Wai Tung Chan, Hong Kong (HK); Kwan Leung Mok, Hong Kong (HK); Ho Yu Wong, Hong Kong (HK)

Correspondence Address: Vincent B. Ingrassia, Motorola, Inc., Suite R3163, P.O. Box 10219, Scottsdale, AZ, 85271-0219, US

(73) Assignee: Motorola, Inc.

(21) Appl. No.: 09/737,145

(22) Filed: Dec. 14, 2000

(51) Int. Cl. G09G 5/37; G09G 5/02

(52) U.S. Cl. 345/563; 345/589

(57) ABSTRACT

A method for modifying a selected data portion (8) of a data item (10) with a bit pattern (36) is disclosed. Said method identifies a data portion (8) to be modified. Said method further selects a field (38) by accessing a plurality of fields (30). Said fields (30) include a plurality of recurring bit patterns (36). Adjacent fields (38, 40) have identical bit patterns offset by at least one bit. Said method selects a mask (58) to obtain a selected one of said bit patterns (36) in said selected field (38) that is aligned with said identified data portion (8). Said method modifies said identified data portion (8) by performing a predetermined bit operation on said identified data portion (8) with said selected one of said bit patterns (36). A processor for performing the above method is also disclosed.

### FIELD OF THE INVENTION

This invention relates, in general, to a method for modifying bit fields in a memory buffer, and more particularly, to a method for modifying non-byte or non-word aligned bit fields in a memory buffer associated with a display device.

### BACKGROUND ART

Typically, a display screen is divided into rows and columns of small units or elemental areas, termed picture elements or pixels. To display an image on the display screen, data representing the image is written to a memory buffer associated with the display screen. The memory buffer contains a block of data items. These data items may be bytes, 16-bit words or 32-bit words. Bit fields in the data items of the memory buffer correspond to the pixels on the display screen. Each bit field typically contains information such as intensity and color of a corresponding pixel. As is known to those skilled in the art, the number of bits required per pixel varies. For a simple 8-colour display, 3 bits are required per pixel. A bit field of such a length results in bit fields that are not aligned with but are offset from the start of a data item. Some bit fields straddle the boundaries between data items.

Modifying such non-aligned bit fields requires substantial processing overhead. A general operation on a misaligned bit field using a microprocessor involves isolation of the bit field from within a data item, manipulation of the bit field, and reintegration of the bit field back into the data item for further processing. Generally, to perform such an operation a microprocessor has to execute instructions such as shift, rotate, and, or, etc. There are other instructions on some microprocessors that allow direct bit manipulation such as bset (bit set) and bclr (bit clear) instructions. However, all these instructions are processor operation intensive with each instruction requiring many cycles of processor time to execute.

One alternative for modifying non-aligned bit fields is to use pre-generated masks and pixel information that are aligned with all possible starting positions of the bit fields to be modified. Although such a method reduces the number of instruction executions, storing the pre-generated masks and pixel information requires a substantial amount of memory.

Another alternative is to use specially built hardware to perform direct manipulation of the bit fields. One such example is that disclosed in U.S. Pat. No. 6,061,783.

### SUMMARY OF THE INVENTION

According to one aspect of the invention there is provided a method for modifying a selected data portion of a data item with a bit pattern. Said method identifies a data portion to be modified. Said method further selects a field by accessing a plurality of fields. Said fields include a plurality of recurring bit patterns. Adjacent fields have identical bit patterns offset by at least one bit. Said method selects a mask to obtain a selected one of said bit patterns in said selected field that is aligned with said identified data portion. Said method modifies said identified data portion by performing a predetermined bit operation on said identified data portion with said selected one of said bit patterns.

Preferably, said method may further identify an offset of said data portion from a start of said data item and said method may use said offset to access said plurality of fields to select said field.

Preferably, said method may select a mask by accessing a plurality of masks using said offset to select a mask.

Suitably, said method should select a field by selecting an index from a plurality of indexes using said offset and accessing said plurality of fields using said selected index to select a field.

Preferably, said data item may be a selected one of a plurality of data items in a memory buffer associated with a display screen wherein said data portion corresponds to a pixel on said display screen. In such an application, said bit pattern may suitably be a color data. Said method then identifies a data portion to be modified by identifying a data item that includes said data portion to be modified. Said method also selects a field by accessing a plurality of color-fields to select a color-field from a subset of color-fields selected based on a color parameter.

Preferably, said method may further check said data portion to determine if said data portion spans an adjacent data item to result in a remaining data portion in said adjacent data item. If it is determined that such a remaining data portion exists, said method modifies said remaining data portion in said adjacent data item in a similar manner as described above by using a selected second field and mask.

According to another aspect of the invention there is provided a data portion processor for modifying a selected data portion of a data item with a bit pattern. Said processor includes a field selector for selecting a field from a plurality of fields. Said fields include a plurality of recurring bit patterns as described above.

Said processor also includes a mask selector for selecting a mask to obtain a selected one of said bit patterns in said selected field that is aligned with said data portion. Said processor further includes a bit operator for modifying said data portion by performing a predetermined bit operation on said data portion with said selected one of said bit patterns.

Preferably, said field selector selects a field from a plurality of fields and said mask selector selects a mask based on an offset of said selected data portion from a start of said data item.

### BRIEF DESCRIPTION OF THE DRAWINGS

In order that the invention may be readily understood and put into practical effect, reference will now be made to preferred embodiments as illustrated with reference to the accompanying drawings in which:

FIG. 1 is an illustration of a display screen and an associated memory buffer;

FIG. 2 is a schematic block diagram showing a memory operatively coupled to a processor, the memory containing program instructions for execution on the processor for interfacing with the display screen and associated memory buffer in FIG. 1;

FIG. 3 is a sequence of steps for modifying a data portion in a data item of the memory buffer according to an embodiment of the invention, where the data portion corresponds to a pixel in the display screen in FIG. 1;

FIG. 4 is an illustration showing how data stored in lookup tables can be used in the sequence in FIG. 3 to modify a selected data portion in a data item;

FIG. 5 is an illustration showing a data item that spans two adjacent data items of the memory buffer of FIG. 1; and

FIG. 6 is a schematic diagram of a data portion processor that performs some of the steps in the sequence in FIG. 3.

### DETAILED DESCRIPTION OF A PREFERRED EMBODIMENT OF THE INVENTION

FIG. 1 shows a display screen 2 and an associated memory buffer 4. An example of the display screen 2 is a liquid crystal display (LCD). The memory buffer 4 is used to store a block of data items 6 typically comprising 16-bit words. Data items of other bit lengths can also be used. Bit fields in the data items 6 correspond to pixels on the display screen 2. FIG. 1 also shows a data portion 8, which in this embodiment is a 3-bit bit field in a selected data item 10 that corresponds to a pixel 12. The data portion 8 contains color information of the pixel 12. One of eight colors can be specified using this 3-bit data portion 8.

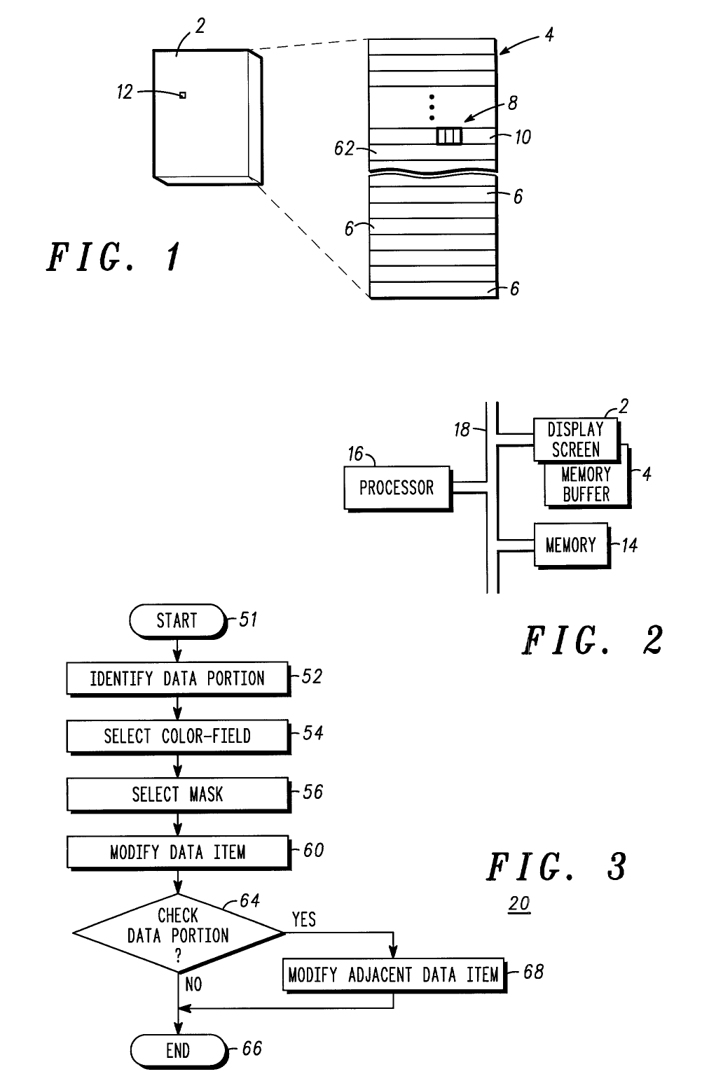

FIG. 2 is a schematic block diagram showing components required for interfacing with the display screen 2. In addition to the memory buffer 4, a memory 14 is operatively coupled to a processor 16 via a bus 18 in a manner well known to those skilled in the art. The processor 16 modifies the data items 6 stored in the memory buffer 4 by executing program instructions readable from the memory 14.

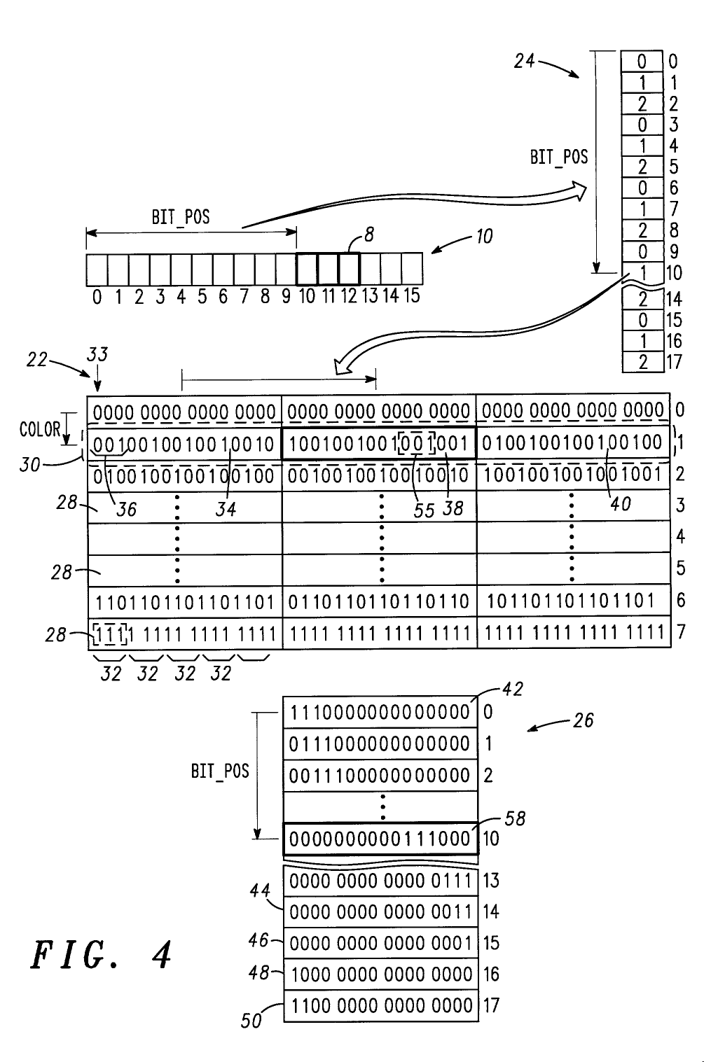

FIG. 4 shows lookup tables (LUTs) that are stored in the memory 14. The LUTs include a color LUT 22, an index LUT 24 and a mask LUT 26. The color LUT 22 has a plurality of color-fields 28 arranged in an eight-by-three two-dimensional array for access by index addressing. The color-fields 28 contain information relating to eight colors. Each color is represented by a subset comprising three color-fields. A subset 30 of blue color-fields is shown enclosed in dotted lines. Each color-field 28 contains recurring 3-bit bit patterns 32 that represent a particular color data. The first bit pattern in a first color-field begins at a start position 33 (bit0 position) of the color-field. For example, the first color-field 34 for the color blue will begin with a blue bit pattern 36 of “001”. Subsequent bits of the first color-field 34 contain recurring blue bit patterns “001”. The second blue color-field 38, adjacent the first blue color-field 34, contains an identical bit pattern as that in the first blue color-field 34 offset by one bit. Instead of starting at a bit0 position 33, the blue bit pattern 36 in the second color-field starts in a bit1 position. The first bit, in the bit0 position, contains the last bit of the blue bit pattern “001”. Similarly, a third blue color-field 40 contains an identical bit pattern as that in the first blue color-field 34 offset by two bits. The first two bits of the third blue color-field 40, in the bit0 and bit1 positions, contain the last two bits of the blue bit pattern “001”. One of the color-fields 34, 38, 40 contains a blue bit pattern “001”that is aligned with the selected 3-bit data portion 8 in the data item 10 of the memory buffer 4. The color-fields 28 for the other seven colors are set in a similar manner.

The index LUT 24 has a plurality of fields containing indexes or index values. For a data item of 16 bits, there are a total of eighteen fields—sixteen fields corresponding to the sixteen bits in a data item and two (given by number of bits in a data portion minus one) additional fields for handling boundary conditions. These boundary conditions will be described later. The index value stored in each field is given by a remainder when the field position in the index LUT 24 is divided by three (number of bits in a data portion). The first field, having a field position of zero, will result in a remainder of zero. The value of the first field is therefore set to zero. Similarly, the second field will have a value of one and the third field will have a value of two, etc.

The mask LUT 26 also has a plurality fields equal to the number of fields in the index LUT 24. Each field contains a 16-bit mask that is used to obtain a selected color bit pattern from a recurring bit pattern in the color LUT 22. The mask in the first field 42 has three consecutive bits of 1's followed by thirteen bits of 0's. Each subsequent field contains a similar mask that is offset by one bit. Two of the fields, fields 44, 46, provide only a partial mask, these fields 44, 46 have less than three bits of 1's. Two following fields, fields 48, 50, also containing a partial mask are therefore provided for use in conjunction with the masks in the fields 44, 46 to handle boundary conditions where a 3-bit data portion straddles the boundary between two data items.

As is known to those skilled in the art, the meaning of a word such as “field” is context dependent. For example, when referring to a table in a memory having a plurality of fields, the word “field” in that context means memory locations. However, when referring to an operation on a field, it should be understood that the word “field” refers to the data contained in a memory location.

Refering to FIG. 3, a sequence of steps 20 for modifying a selected data portion 8 of the memory buffer 4 is described. The sequence 20 begins in a START step 51, when the processor 16 is instructed to modify the pixel 12 in the display screen 2. At this time, the processor 16 is provided with a color parameter (color) and a modify mode that indicates how the pixel 12 is to be modified. To aid in describing the operation of the sequence 20, consider an example in which the pixel 12 is to be modified with a blue color data. The color parameter in the example would therefore indicate the color blue (color=1).

The sequence 20 next proceeds to an IDENTIFY DATA PORTION step 52, where the processor 16 determines the data portion 8 in the data item 10 that corresponds to the pixel 12. The data item 10 in the memory buffer 4 is identified by an index (pos) for indexing into the memory buffer 4. The data item is given by a pseudo code:

memory_buffer[pos]

The processor 16 also determines an offset or a starting bit position (bit_pos) of the data portion 8 in the data item 10. FIG. 4 shows the starting bit position to be bit10 in the data item 10, i.e., bit_pos is equal to the value ten.

The sequence 20 next proceeds to a SELECT COLOR-FIELD step 54, where the color parameter is used for accessing the color LUT 22 to obtain the subset 30 of blue color-fields 34, 38, 40 corresponding to the color parameter. A pseudo code for selecting the subset is:

Color_LUT[color]

The starting bit position (bit_pos) is used next to access the index LUT 24 to obtain an index value. The index value is then used to eventually select one of the color-fields 34, 38, 40. A pseudo code for selecting the index from the index LUT 24 is:

Index_LUT[bit_pos]

As illustrated in FIG. 4, indexing into the index LUT 24 will return an index value of one. A pseudo code for selection of the color-field 38 from the subset 30 is:

Color_LUT[color][IndexLUT[bit_pos]]

For this example, the second blue color-field 38 is selected. It should be noted that in the selected color-field 38 is a blue bit pattern “001” 55 which is aligned with the data portion 8 of the data item 10.

The sequence 20 next proceeds to a SELECT MASK step 56, where a mask is selected by accessing the mask LUT 26 with the starting position (bit_pos) of the data portion 8. A pseudo code selecting the mask from the mask LUT 26 is:

Mask_LUT[bit_pos]

It can be seen from FIG. 4 that a mask 58 of “0000000000111000” is selected. The three bits of 1's in the selected mask are aligned in bit position with the data portion 8.

After selecting the color-field 38 and mask 58 from the respective LUTs 22, 24, 26, the sequence 20 proceeds to a MODIFY DATA ITEM step 60, where a bit operation corresponding to the modify mode is performed on the data item 10 using the selected color-field 38 and the mask 58. The modify mode includes modes such as “AND”, “OR”, “EXCLUSIVE OR” and “REPLACEMENT” modes as are known to those skilled in the art. The following pseudo code performs a bit operation on the data item 10 for an “AND” modify mode:

mem_buf[pos]=mem_buf[pos] AND (Color_LUT[blue][Index_LUT[bit_pos]] OR (NOT Mask_LUT[bit_pos]))

For the example, the above pseudo code is computed as follows:

mem_buf[pos] = mem_buf[pos] AND (ColorLUT[1][indexLUT[10]] OR
(NOT mask_LUT[10]))
mem_buf[pos] = mem_buf[pos] AND (colorLUT[1][1] OR
(NOT 0000000000111000))
mem_buf[pos] = mem_buf[pos] AND (1001001001001001 OR
1111111111000111)
mem_buf[pos] = mem_buf[pos] AND (1111111111001111)

Similarly, the following pseudo code performs a bit operation on the data item 10 for an “OR” modify mode:

mem_buf[pos]=mem_buf[pos] OR (Color_LUT[blue][Index_LUT[bit_pos]]AND MaskLUT[bit_pos])

For the example, the above pseudo code is computed as follows:

mem_buf[pos] = mem_buf[pos] OR (ColorLUT[1][indexLUT[10]] AND
maskLUT[10])
mem_buf[pos] = mem_buf[pos] OR (colorLUT[1][1] AND
0000000000111000)
mem_buf[pos] = mem_buf[pos] OR (1001001001001001 OR
0000000000111000)
mem_buf[pos] = mem_buf[pos] OR (0000000000001000)

Note that in each of the above bit operations, only the data portion 8 in the data item 10 is modified.

Following the modification of the data item 10, the sequence 20 proceeds to check if the data portion 8 spans an adjacent data item 62 (FIG. 1) in a CHECK DATA PORTION step 64. If it is determined that the data portion 8 does not span the adjacent data item 62, which is the case in the example in FIG. 4, the sequence 20 ends in an END step 66 to signify completion of modification of the data portion 8. If however, it is determined that a data portion spans the adjacent data byte 62, the sequence 20 proceeds to a MODIFY ADJACENT DATA ITEM step 68. In step 68, a remainder of the data portion that resides in the adjacent data item 32 is modified using a selected second color-field and a selected second mask. A pseudo code for performing a bit operation on the adjacent data item 32 is:

mem_buf[pos+1]=mem_buf[pos+1] AND (Color_LUT[blue][Index_LUT[bit_pos+2]] OR (NOT MaskLUT[bit_pos+2]))

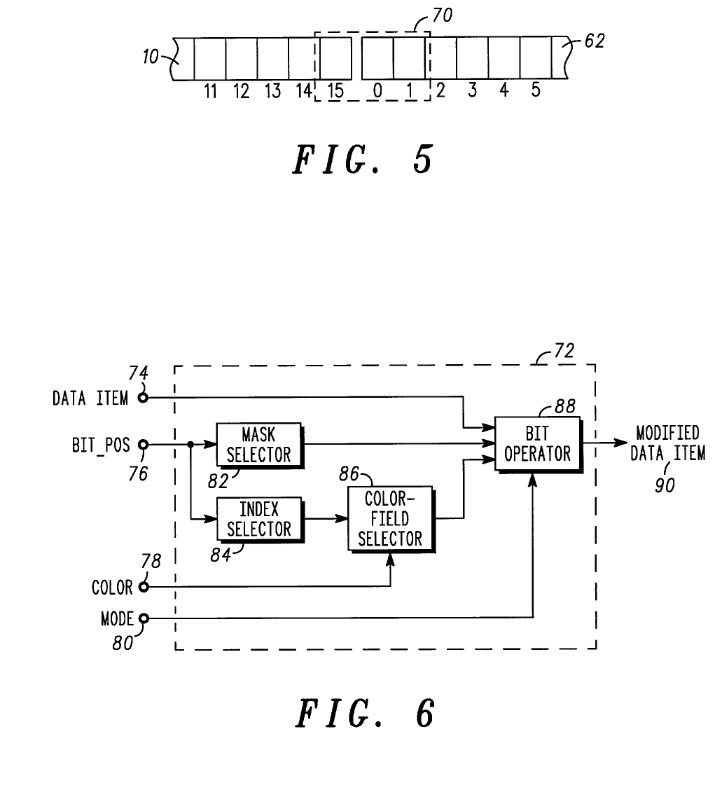

This modification of the adjacent data item 32 is best described with the aid of another example as shown in FIG. 5. A data portion 70 is shown to span two adjacent data items 10, 62. The first bit of the data portion 70 resides in the data item 8. The starting bit position (bit_pos) of this data portion 70 is equal to fifteen. The remaining two bits reside in the data item 62. The modifying of the data portion 70 using an “AND” mode is next described with reference to a complete pseudo code for performing steps 60, 64, 68 of the sequence 20:

mem_buf[pos] = mem_buf[pos] AND (Color_LUT[blue][Index_LUT[bit_pos]] OR (NOT MaskLUT[bit_pos]))
if (portion spans two adjacent bytes)
mem_buf[pos+1] = mem_buf[pos+1] AND (Color_LUT[blue][Index_LUT[bit_pos+2]] OR (NOT
MaskLUT[bit_pos+2]))

Following the steps previously described, the first bit of the data portion 70 would have been modified at the MODIFY DATA ITEM step 60. The data item 8 in an “AND” modify mode would have its last bit modified as follows:

mem_buf[pos] = mem_buf[pos] AND (Color_LUT[blue][Index_LUT[bit_pos]] OR (NOT MaskLUT[bit_pos]))
mem_buf[pos] = mem_buf[pos] AND (Color_LUT[blue][Index_LUT[15]] OR (NOT MaskLUT[15]))
mem_buf[pos] = mem_buf[pos] AND (Color_LUT[1][0] OR (NOT 0000000000000001))
mem_buf[pos] = mem_buf[pos] AND (0010010010010010 OR 1111111111111110)
mem_buf[pos] = mem_buf[pos] AND 1111111111111110

According to the third line of the pseudo code above, the data portion 62 in an “AND” modify mode would have its first two bits modified as follows:

mem_buf[pos+1] = mem_buf[pos+1] AND (Color_LUT[blue][Index_LUT[bit_pos+2]] OR (NOT
MaskLUT[bit_pos[2]))
mem_buf[pos+1] = mem_buf[pos+1] AND (Color_LUT[blue][Index_LUT[17]] OR (NOT MaskLUT[17]))
mem_buf[pos+1] = mem_buf[pos+1] AND (Color_LUT[1][2] OR (NOT 1100000000000000))
mem_buf[pos+1] = mem_buf[pos+1] AND (0100100100100100 OR 0011111111111111)
mem_buf[pos+1] = mem_buf[pos+1] AND 0111111111111111

FIG. 6 shows a schematic block diagram of a hardware data portion processor 72. The data portion processor 72 implements part of the sequence 20 described above. The data portion processor 72 has inputs for receiving a data item 74 containing a data portion to be modified, a starting bit position 76 of the data portion in the data item 74, a color parameter 78 and a modify mode 80. A mask selector 82 selects a mask from a plurality of masks based on the starting bit position. Similarly, an index selector 84 selects an index from a plurality of indexes corresponding to the starting bit position. A color-field selector 86 selects a color-field corresponding to the color parameter and the index from the index selector. Each color field has a recurring bit pattern as described above. A bit operator 88 performs a bit operation on the data item 74 using the selected mask and color-field to produce a modified data item on an output 90 of the data item processor 72.

Advantageously, the method described above requires less processing power compared to one that involves execution of “shift” or “rotate” instructions. Such a method allows a less powerful microprocessor to be used to perform a task which previously required a more powerful microprocessor. Software code including instructions for performing the method is also more compact. Less memory is also required for the LUTs 22, 24, 26 as compared to that required for storing pre-generated masks and pixel information that are aligned with all possible starting positions of the data portion to be modified.

Although the invention has been described with reference to the preferred embodiment, it is to be understood that the invention is not restricted to the embodiment described herein. For example, data portions of other bit lengths may be used. The LUTs may also contain other types of bit patterns.

We claim:

1. A method for modifying a selected data portion of a data item with a bit pattern, said method comprising:
identifying a data portion to be modified;
selecting a field by accessing a plurality of fields, said field comprising a plurality of recurring bit patterns, wherein adjacent fields have identical bit patterns offset by at least one bit;
selecting a mask to obtain a selected one of said bit patterns in said selected field that is aligned with said identified data portion; and
modifying said identified data portion by performing a predetermined bit operation on said identified data portion with said selected one of said bit patterns.

2. A method according to claim 1, wherein:
identifying a data portion further includes identifying an offset of said data portion from a start of said data item; and
selecting a field includes accessing said plurality of fields using said offset to select a field.

3. A method according to claim 2, wherein:
selecting a mask includes accessing a plurality of masks using said offset to select said mask.

4. A method according to claim 3, wherein:
selecting a field further includes selecting an index from a plurality of indexes using said offset and accessing said plurality of fields using said selected index to select a field.

5. A method according to claim 1, wherein:
said data item is a selected one of a plurality of data items in a memory buffer associated with a display screen;
said data portion corresponds to a pixel on said display screen;
said bit pattern is a color data;
identifying a data portion to be modified includes identifying a data item that includes said data portion to be modified; and
selecting a field includes selecting a color-field by accessing a plurality of color- fields to select a color-field from a subset of color-fields selected based on a color parameter.

6. A method according to claim 1, further including:
checking said data portion to determine if said data portion spans an adjacent data item to result in a remaining data portion in said adjacent data item; and
modifying said adjacent data item by selecting a second field and a second mask and modifying said remaining data portion in a similar manner as modifying said data portion in said data item.

7. A data portion processor for modifying a selected data portion of a data item with a bit pattern, said processor comprising:
a field selector for selecting a field from a plurality of fields, said fields comprising a plurality of recurring bit patterns, wherein adjacent fields have identical bit patterns offset by at least one bit;
a mask selector for selecting a mask to obtain a selected one of said bit patterns in said selected field that is aligned with said data portion; and
a bit operator for modifying said data portion by performing a predetermined bit operation on said data portion with said selected one of said bit patterns.

8. A data portion processor according to claim 7, wherein said field selector selects a field from a plurality of fields and said mask selector selects a mask based on an offset of said selected data portion from a start of said data item.
